(19) United States
(12) Patent Application Publication
(10) Pub. No.: US 2026/0145282 A1
(43) Pub. Date: May 28, 2026

(54) METHOD AND APPARATUS FOR FRICTION-BASED REPAIR OF DIE CASTING DEFECTS

(71) Applicant: Spartan Light Metal Products, Inc., St. Louis, MO (US)

(72) Inventors: Christopher A. Sleath, Ortonville, MI (US); Scott P. Meyer, Waterloo, IL (US); Nigel J. Doerge, Sparta, IL (US); Samuel Holdsworth, Cambridge (GB); Oliver Watts, Cambridge (GB); Nathan Horrex, Cambridge (GB); Russell Wymer, JR., Millbury, OH (US); Timothy R. Rutkowski, JR., Rossford, OH (US)

(21) Appl. No.: 19/395,114

(22) Filed: Nov. 20, 2025

Related U.S. Application Data
(60) Provisional application No. 63/724,539, filed on Nov. 25, 2024.

(51) Int. Cl. B23P 6/04

(52) U.S. Cl. CPC B23P 6/04

(57) ABSTRACT

A method of repairing a casting defect in a die-cast part includes operating a mechanical bit within a void space formed in a die-cast part to generate plasticized local material along an inner surface of the void space to close one or more casting defects in a vicinity of the void space. The void space may be a hole bored in the part, or a channel or passage formed in the part. The casting defect may be a porosity formed in the part. A tool for repairing a casting defect in a die-cast part includes a bit operable by a drill. The bit includes a shank and an elongated body extending in an axial direction from the shank. The body is configured to generate plasticized local material along a surface defining a void space in a die-cast part. The plasticized local material closes a casting defect formed in the part, and plasticized material may flow into the casting defect.

### CROSS REFERENCE TO RELATED APPLICATIONS

This application claims the benefit of U.S. Provisional Application No. 63/724,539, filed Nov. 25, 2024, the disclosure of which is incorporated herein by reference in its entirety.

### FIELD OF THE INVENTION

The disclosure generally relates to die-cast parts, and more particularly, to sealing casting defects in void spaces formed in die-cast parts.

### BACKGROUND OF THE INVENTION

It is known in the art relating to die casting, and particularly to high-pressure die casting, that porosities may be formed in a die-cast part 60, especially thick sections of the part, from gas entrapment or shrink during the die casting process. When bores are later formed in porous sections of the die-cast part, such as when screw holes are drilled, a porosity or chain of porosities may connect the screw hole 62 to a passage or chamber 66 within the die-cast part 60 as shown pictorially in FIG. 1 and schematically in FIG. 2. Casting defects may also exist along other open spaces within the die-cast part such as channels or passages in the die-cast part. The porosity or chain of porosities thereby forms a leak path from within the die-cast part to the external atmosphere or a leak path from one internal passage to another (cross-talk), which may allow for the leakage of fluid from or within the die-cast part during use of the part. One method of sealing the leak path from within the screw hole or other bore or opening formed in the die-cast part is to inject a resin into the screw hole or other opening to impregnate the porosities with the resin and thereby form a seal within the screw hole or other opening. However, from a practical standpoint, this method is tedious and time-consuming. Also, this method adds an additional cost to the die-cast part and introduces another material to the die-cast part which may be undesirable. Therefore, a need exists for an improved method of repairing/sealing porosities in die-cast parts.

### BRIEF SUMMARY

An improved method of repairing a casting defect in a die-cast part is provided. The method includes operating a mechanical bit within a void space formed in a die-cast part to generate plasticized local material along an inner surface of the void space by friction to close one or more casting defects in a vicinity of the void space. The plasticized material may cover over the casting defect and/or plasticized material may flow into the casting defect.

In specific embodiments, the void space is a hole formed or bored in the die-cast part, a channel formed in the die-cast part, or a passage formed in the die-cast part. The void space may be formed during the casting of the die-cast part or may be formed by drilling/boring the die-cast part after casting.

In specific embodiments, the casting defect is a porosity feature formed in the die-cast part. The casting defect is formed during the casting of the die-cast part.

In various embodiments, a method of repairing a casting defect in a die-cast part includes the step of providing a tool including a mechanical bit. The mechanical bit includes a shank and a body extending from the shank in an axial direction. The method further includes actuating the tool to rotate the mechanical bit. The method further includes advancing the mechanical bit in at least one of the axial direction or a radial direction into a void space formed in the die-cast part. Friction between the mechanical bit and a surface within the void space generates heat to plasticize local die-cast material at the surface to close the casting defect in a vicinity of the surface of the void space, thereby sealing the surface within the void space.

In specific embodiments, the tool forms a plasticized layer along the surface within the void space.

In specific embodiments, the tool forms a plasticized layer around the entirety of the void space.

In specific embodiments, the tool is advanced in both the axial direction and the radial direction.

In specific embodiments, the mechanical bit is rotated at a rate of up to 15,000 rpm, optionally of up to 3,000 rpm.

In specific embodiments, the mechanical bit is advanced at a rate of between 10 mm/min and 500 mm/min, optionally up to 200 mm/min.

In specific embodiments, the body of the mechanical bit includes a cylindrical surface and a blunt head at an end of the cylindrical surface.

A tool for repairing a casting defect in a die-cast part is also provided. The tool includes a mechanical bit operable by an actuator device. The mechanical bit includes a shank configured to fit into the actuator device, and an elongated body extending in an axial direction from the shank. The body is configured to generate plasticized local material along a surface defining a void space in a die-cast part. The plasticized local material closes a casting defect formed in the die-cast part.

In specific embodiments, the body includes a working portion, and the working portion includes a head at a distal end.

In specific embodiments, the head includes a blunt surface.

In specific embodiments, the head is rounded.

In specific embodiments, the head terminates in a tip that is a flat surface.

In specific embodiments, the working portion is cylindrical, and the head is rounded.

In specific embodiments, the working portion includes a plurality of lobes.

In particular embodiments, the lobes are straight in the axial direction of body.

In particular embodiments, the lobes are curved in the axial direction of the body.

In certain embodiments, the lobes are helical.

In particular embodiments, the lobes are flat in a radial direction of the body.

In particular embodiments, the lobes are curved in a radial direction of the body.

In specific embodiments, the working portion is tapered in the axial direction of the body.

In specific embodiments, the working portion has a generally constant cross-sectional shape between the shank and the head.

In specific embodiments, the working portion has a polygonal cross-sectional shape.

In specific embodiments, the working portion includes threads.

In particular embodiments, the working portion further includes helical lobes, and the threads overlap the helical lobes.

In certain embodiments, the threads turn in the same direction as the lobes.

In certain embodiments, the threads turn in an opposite direction as the lobes.

In specific embodiments, the working portion includes a cylindrical section and an increased diameter section, the increased diameter section being adjacent the cylindrical section and between the cylindrical portion and the head.

In particular embodiments, the increased diameter section includes one or more helical lobes.

In particular embodiments, the increased diameter section includes a plurality of flat, straight lobes.

In various embodiments, a method of repairing a casting defect in a die-cast part includes the step of operating a tool according to any of the embodiments above.

### DESCRIPTION OF THE DRAWINGS

Various advantages and aspects of this disclosure may be understood in view of the following detailed description when considered in connection with the accompanying drawings, wherein:

FIG. 1 is a pictorial view of a section of a die-cast part illustrating a chain of porosities in the die-cast part that form a leak path to a drilled screw hole, as found in the prior art;

FIG. 2 is a schematic view of a porosity in a die-cast part opened by a drilled and tapped screw hole;

FIG. 3 is a flowchart of a method of repairing a casting defect in a die-cast part in accordance with embodiments of the disclosure;

FIG. 4 is a schematic view of a section of the die-cast part illustrating a casting defect adjacent a void space pre-formed in the die-cast part;

FIG. 5 is a schematic view of a section of the die-cast part illustrating pilot drilling of the void space to form a pilot hole in accordance with the method;

FIG. 6 is a schematic view of a section of the die-cast part illustrating friction milling of the pilot hole to plasticize the local die-cast material and form a plasticized hole that closes the casting defect in a vicinity of the surface of the pilot hole and seals the leak path in accordance with the method;

FIG. 7 is a schematic view of a section of the die-cast part illustrating tapping of the plasticized hole to form a ready-to-use threaded bolt hole in accordance with the method;

FIG. 8 is a schematic view of a section of the die-cast part illustrating the ready-to-use threaded bolt hole in accordance with the method;

FIG. 9 is a pictorial view of a tool including a mechanical bit in accordance with embodiments of the disclosure, advancing into a workpiece and subsequently retracted from the workpiece;

FIG. 10 is a schematic view of movement of a mechanical bit relative to a void space in a die-cast part when advanced in a linear/axial direction in accordance with embodiments of the disclosure;

FIG. 11 is a schematic view of movement of a mechanical bit relative to a void space in a die-cast part when advanced in a radial/orbital direction in accordance with other embodiments of the disclosure;

FIG. 12 is a schematic view of a test arrangement for a mechanical bit in accordance with various embodiments of the disclosure;

FIG. 13A is a pictorial view of a cross-section of a test workpiece after operation of a mechanical bit in accordance with various embodiments of the disclosure within a void space formed in the workpiece;

FIG. 13B is an enlarged view of a left-hand portion of the cross-section of the test workpiece of FIG. 13A;

FIG. 13C is an enlarged view of a right-hand portion of the cross-section of the test workpiece of FIG. 13A;

FIG. 14 is another enlarged view of the cross-section of the test workpiece of FIG. 13A;

FIG. 15A is a side view of a mechanical bit of a tool in accordance with some embodiments of the disclosure;

FIG. 15B is a front view of the mechanical bit of FIG. 15A;

FIG. 16A is a perspective view of a mechanical bit of a tool in accordance with other embodiments of the disclosure;

FIG. 16B is a side view of the mechanical bit of FIG. 16A;

FIG. 16C is a front view of the mechanical bit of FIG. 16A;

FIG. 17A is a side view of a mechanical bit of a tool in accordance with yet other embodiments of the disclosure;

FIG. 17B is a front view of the mechanical bit of FIG. 17A;

FIG. 18A is a side view of a mechanical bit of a tool in accordance with yet other embodiments of the disclosure;

FIG. 18B is a front view of the mechanical bit of FIG. 18A;

FIG. 19A is a perspective view of a mechanical bit of a tool in accordance with yet other embodiments of the disclosure;

FIG. 19B is a side view of the mechanical bit of FIG. 19A;

FIG. 19C is a front view of the mechanical bit of FIG. 19A;

FIG. 20A is a side view of a mechanical bit of a tool in accordance with yet other embodiments of the disclosure;

FIG. 20B is a front view of the mechanical bit of FIG. 20A;

FIG. 21A is a side view of a mechanical bit of a tool in accordance with yet other embodiments of the disclosure;

FIG. 21B is a front view of the mechanical bit of FIG. 21A;

FIG. 22A is a side view of a mechanical bit of a tool in accordance with yet other embodiments of the disclosure;

FIG. 22B is a front view of the mechanical bit of FIG. 22A;

FIG. 23A is a side view of a mechanical bit of a tool in accordance with yet other embodiments of the disclosure;

FIG. 23B is a front view of the mechanical bit of FIG. 23A;

FIG. 24 is a side view of a mechanical bit of a tool in accordance with yet other embodiments of the disclosure;

FIG. 25 is a side view of a mechanical bit of a tool in accordance with yet other embodiments of the disclosure;

FIG. 26 is a side view of a mechanical bit of a tool in accordance with yet other embodiments of the disclosure;

FIG. 27 is a side view of a mechanical bit of a tool in accordance with yet other embodiments of the disclosure;

FIG. 28A is a side view of a mechanical bit of a tool in accordance with yet other embodiments of the disclosure;

FIG. 28B is a front view of the mechanical bit of FIG. 28A;

FIG. 29 is a side view of a mechanical bit of a tool in accordance with yet other embodiments of the disclosure;

FIG. 30A is a perspective view of a mechanical bit of a tool in accordance with specific embodiments of the disclosure;

FIG. 30B is a side view of the mechanical bit of FIG. 30A;

FIG. 30C is a front view of the mechanical bit of FIG. 30A;

FIG. 31A is a perspective view of a mechanical bit of a tool in accordance with other specific embodiments of the disclosure;

FIG. 31B is a side view of the mechanical bit of FIG. 31A;

FIG. 31C is a front view of the mechanical bit of FIG. 31A;

FIG. 32A is a perspective view of a mechanical bit of a tool in accordance with yet other specific embodiments of the disclosure;

FIG. 32B is a side view of the mechanical bit of FIG. 32A;

FIG. 32C is a front view of the mechanical bit of FIG. 32A; and

FIG. 33 is a graph of load versus displacement illustrating load failure rates in a bolt hole formed according to methods of the disclosure in comparison to a bolt hole formed according to the prior art.

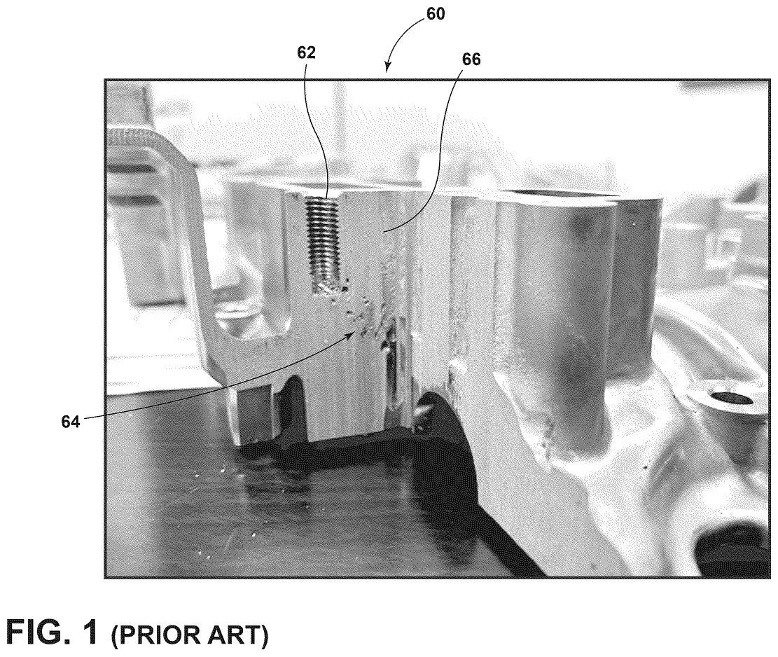

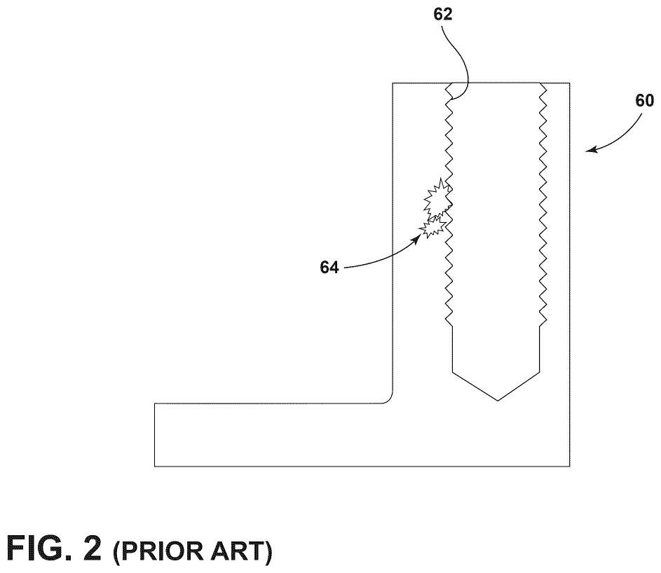

### DETAILED DESCRIPTION OF THE INVENTION

A method of repairing a casting defect in a die-cast part and a tool for use in the method are provided. The method and associated tool allow for the quick, facial, and low-cost repair of casting defects at and around screw holes, bores, channels and/or passages formed in the die-cast part. The method also modifies the material surrounding and forming the screw hole, bore, channel and/or passage by refining the grain structure of the existing material without introducing any new and/or different material to the die-cast part. The method generally includes actuating a tool including a mechanical bit that is capable of performing work on the die-cast part to rotate the mechanical bit on its axis and to advance the mechanical bit in an axial and/or radial direction into a void space in the die-cast part to generate plasticized local material along an inner surface of the void space by friction to close one or more casting defects in a vicinity of the void space. Each step of the method is described in greater detail below.

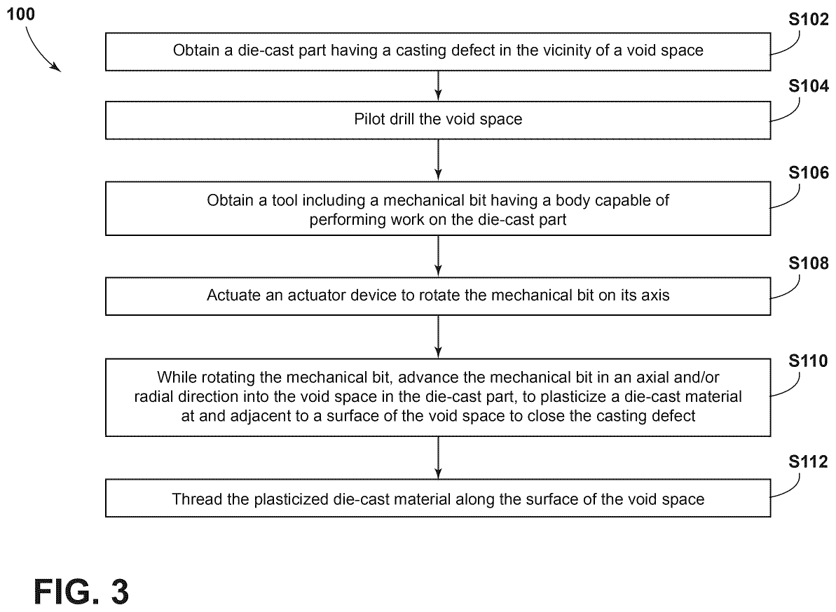

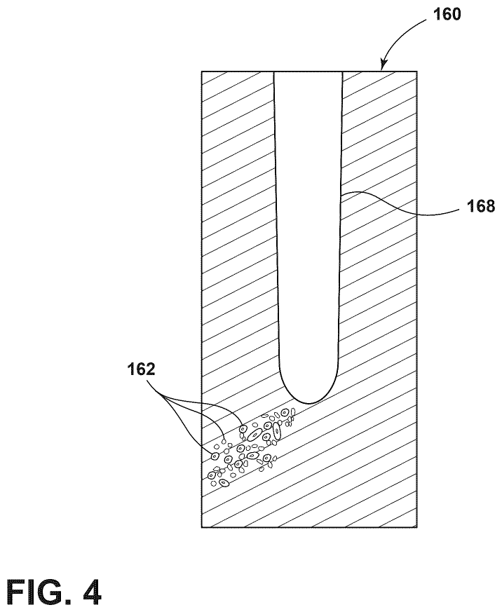

With reference first to FIGS. 3-8, at step S102 the method 100 first includes obtaining a die-cast part that includes a casting defect at or in the vicinity of a void space such as a screw hole, bore, channel, or passage pre-formed in the die-cast part. By “pre-formed,” it is meant that the screw hole, bore, channel, or passage is formed in the die-cast part during the casting process, or the screw hole, bore, channel, or passage has been drilled, bored, or the like into the die-cast part at a time prior to the start of the method. As shown schematically in FIG. 4, the casting defect may be one or more porosities 162 formed in the die-cast part 160 during the casting process, and the porosities 162 are located near a void space such as, for example, an as-cast hole 168 in the die-cast part 160. If a screw hole such as but not limited to a M8 or M6-sized screw hole were to be drilled/tapped in the as-cast hole 168 of the die-cast part 160, the screw hole would expose the porosity to the external environment, thereby forming an undesired opening/defect along the wall that defines the screw hole. Further, the porosities 162 may be disposed in a chain that forms a leak path from within an internal space of the die-cast part to the screw hole such that when the die-cast part is put into use, fluid may leak from the internal space of the die-cast part to the screw hole. The casting defects are therefore subsurface defects formed within the die-cast part and opened to the external atmosphere when a hole or bore is drilled into the die-cast part, or the casting defects are subsurface defects that are adjacent to and/or in the vicinity of an internal channel or passage formed within the die-cast part. In some embodiments, the material forming the die-cast part may be, for example, an aluminum-based alloy. In other embodiments, the material may be a magnesium-based alloy or other metal alloy. It should be understood that the cross-hatch in FIGS. 4-8 schematically represents material forming the die-cast part but does not indicate any particular material or physical property of the material.

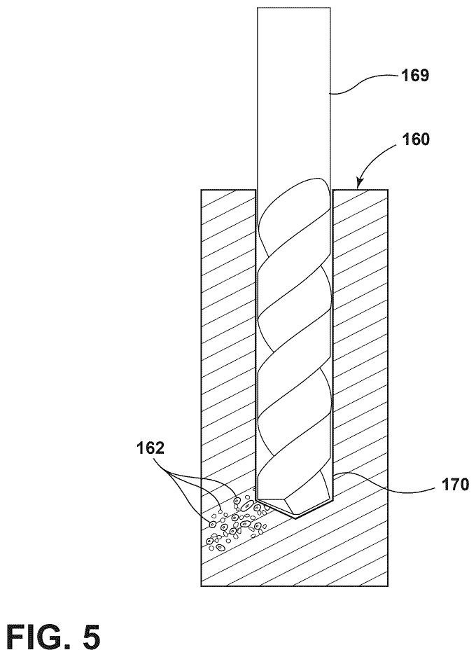

At step S104, the method next includes pilot drilling the as-cast hole 168 to provide donor material in the area of the die-cast part 160 surrounding the as-cast hole as shown schematically in FIG. 5. The pilot drilling may be accomplished using a conventional drill bit 169 or other suitable bit capable of pilot drilling the as-cast hole 168 to form a pilot hole 170. The pilot hole 170 opens the porosities 162 to the void space within the pilot hole 170.

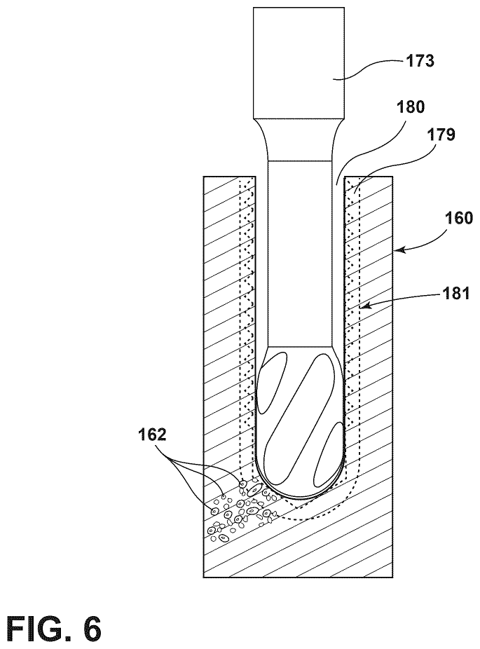

Turning to FIG. 6, the method next includes operating a mechanical bit 173 within the pilot hole drilled in the void space, by example a bolt hole formed in a die-cast part, to generate plasticized local material 179 along an inner surface of the void space. More particularly, at step S106 the method 100 includes providing, obtaining, and/or utilizing a specific tool. The tool, which is described in greater detail below, generally includes a mechanical bit having a shank and a body, the body extending axially from the shank in an axial direction along the central axis of the shank. The body constitutes a working portion of the tool that performs work on the die-cast part, while the shank is receivable in a chuck or other similar receiver of an actuator device such as a drill or similar that is capable of rotating and/or advancing the mechanical bit (rotational, translational, and/or orbital movement in the axial and/or radial directions).

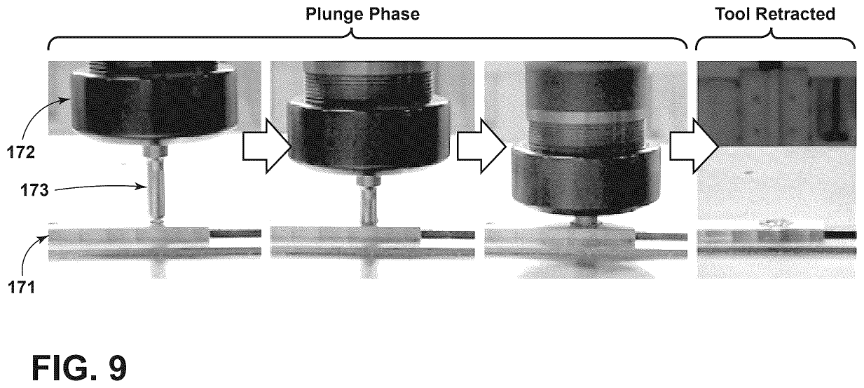

As shown schematically in FIG. 9, the die-cast part 171 and actuator device 172 are positioned such that the mechanical bit 173 is aligned with the pilot hole. At step S108, the actuator device is actuated to rotate the mechanical bit 173 about its longitudinal axis. In some embodiments, the rotational speed of the mechanical bit 173 may be up to approximately 3000 rpm or more, optionally in the range of 2900 to 3100 rpm, optionally in the range of 2800 to 3200 rpm, optionally in the range of 2700 to 3300 rpm, optionally in the range of 2600 to 3400 rpm, optionally in the range of 2500 to 3500 rpm, optionally in the range of 2900 to 3000 rpm, optionally in the range of 2800 to 3000 rpm, optionally in the range of 2700 to 3000 rpm, optionally in the range of 2600 to 3000 rpm, optionally in the range of 2500 to 3000 rpm, optionally in the range of 3000 to 3100 rpm, optionally in the range of 3000 to 3200 rpm, optionally in the range of 3000 to 3300 rpm, optionally in the range of 3000 to 3400 rpm, optionally in the range of 3000 to 3500 rpm. In yet other embodiments, the rotational speed of the mechanical bit may be up to approximately 15,000 rpm, optionally up to approximately 14,000 rpm, optionally up to approximately 13,000 rpm, optionally up to approximately 12,000 rpm, optionally up to approximately 11,000 rpm, optionally up to approximately 10,000 rpm, optionally up to approximately 9,000 rpm, optionally up to approximately 8,000 rpm, optionally up to approximately 7,000 rpm, optionally up to approximately 6,000 rpm, optionally up to approximately 5,000 rpm, optionally up to approximately 4,000 rpm, optionally in the range of 2,500 to 15,000 rpm, optionally in the range of 2,500 to 14,000 rpm, optionally in the range of 2,500 to 13,000 rpm, optionally in the range of 2,500 to 12,000 rpm, optionally in the range of 2,500 to 11,000 rpm, optionally in the range of 2,500 to 10,000 rpm, optionally in the range of 2,500 to 9,000 rpm, optionally in the range of 2,500 to 8,000 rpm, optionally in the range of 2,500 to 7,000 rpm, optionally in the range of 2,500 to 6,000 rpm, optionally in the range of 2,500 to 5,000 rpm, optionally in the range of 2,500 to 4,000 rpm. At step S110, the mechanical bit 173 is advanced in either or both of the axial direction and the radial direction into the pilot hole formed in the die-cast part.

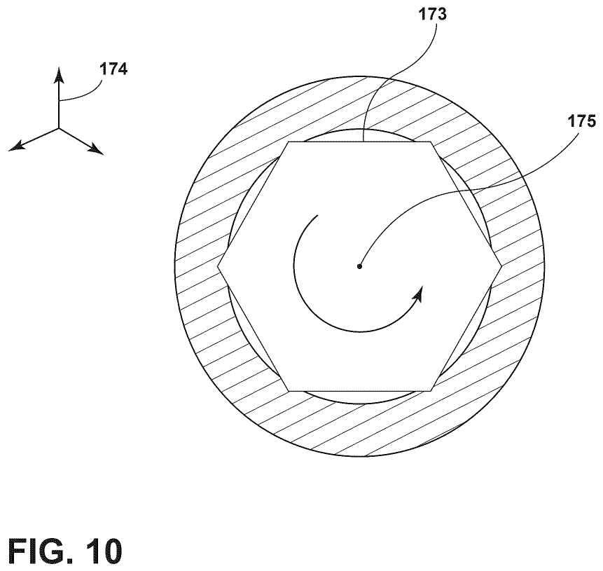

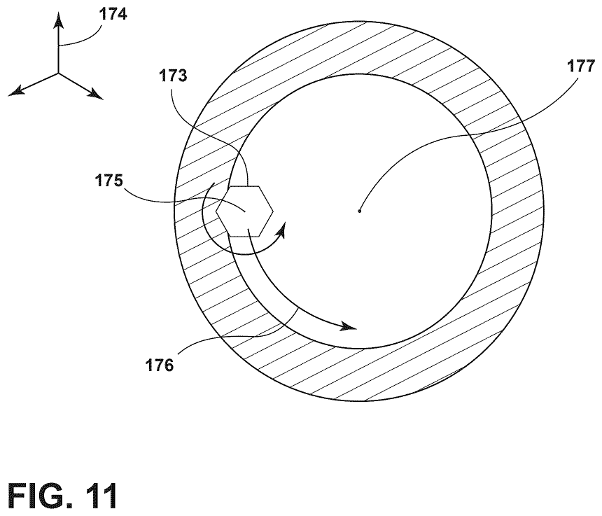

While rotating the mechanical bit 173, a first option is to advance the mechanical bit 173 in the axial direction 174 by moving the actuator device linearly in a direction parallel to the axis 175 of the mechanical bit 173 (plunging movement) while rotating the mechanical bit on its axis 175 as shown in FIG. 10. Alternatively, a second option is to advance the mechanical bit 173 in the radially direction 176 by orbiting the mechanical bit about a center point 177 that may be concentric with a center point of the pilot hole or other void space such that the mechanical bit 173 traverses the surface of the pilot hole or other void space as it orbits about the center point (orbiting movement) while rotating the mechanical bit 173 on its axis 175 as shown in FIG. 11. Further, a third option is to advance the mechanical bit in a combination of both plunging movement and orbiting movement. As shown by example in FIG. 9, the mechanical bit is advanced linearly in a plunging movement in the axial direction such that the mechanical bit is slowly plunged into the pilot hole. In some embodiments, the rate of advancement of the mechanical bit may be up to approximately 200 mm/minute or greater, optionally up to 220 mm/minute, optionally up to 240 mm/minute, optionally up to 260 mm/minute, optionally up to 280 mm/minute, optionally up to 300 mm/minute, optionally up to 320 mm/minute, optionally up to 340 mm/minute, optionally up to 360 mm/minute, optionally up to 380 mm/minute, optionally up to 400 mm/minute, optionally up to 420 mm/minute, optionally up to 440 mm/minute, optionally up to 460 mm/minute, optionally up to 480 mm/minute, optionally up to 500 mm/minute, optionally between 10 and 200 mm/minute, optionally between 20 and 200 mm/minute, optionally between 30 and 200 mm/minute, optionally between 40 and 200 mm/minute, optionally between 50 and 200 mm/minute, optionally between 60 and 200 mm/minute, optionally between 70 and 200 mm/minute, optionally between 80 and 200 mm/minute, optionally between 90 and 200 mm/minute, optionally between 100 and 200 mm/minute, optionally between 110 and 200 mm/minute, optionally between 120 and 200 mm/minute, optionally between 130 and 200 mm/minute, optionally between 140 and 200 mm/minute, optionally between 150 and 200 mm/minute, optionally between 160 and 200 mm/minute, optionally between 170 and 200 mm/minute, optionally between 180 and 200 mm/minute, optionally between 190 and 200 mm/minute, optionally approximately 10 mm/minute, optionally approximately 20 mm/minute, optionally approximately 30 mm/minute, optionally approximately 50 mm/minute, optionally approximately 100 mm/minute, optionally approximately 150 mm/minute, optionally approximately 200 mm/minute. optionally between 50 mm/minute and 500 mm/minute, optionally between 100 mm/minute and 500 mm/minute, optionally between 150 mm/minute and 500 mm/minute, optionally between 200 mm/minute and 500 mm/minute, optionally between 300 mm/minute and 500 mm/minute, optionally between 400 mm/minute and 500 mm/minute, optionally between 50 mm/minute and 400 mm/minute, optionally between 50 mm/minute and 300 mm/minute, optionally between 50 mm/minute and 250 mm/minute, optionally approximately 10 mm/minute, optionally approximately 20 mm/minute, optionally approximately 30 mm/minute, optionally approximately 50 mm/minute, optionally approximately 100 mm/minute, optionally approximately 150 mm/minute, optionally approximately 200 mm/minute. During rotation and advancement of the mechanical bit 173, friction alone between the mechanical bit and the surface of the void space such as the cylindrical wall of the pilot hole 170 (FIG. 5) generates heat that plasticizes local die-cast material 179 (material along the surface of the pilot hole and in the close vicinity of the pilot hole) of the die-cast part 160. Once the mechanical bit 173 has been sufficiently and/or fully advanced into the pilot hole 170 and has completed work on the pilot hole, the mechanical bit 173 is retracted and removed from the pilot hole as shown schematically in FIG. 9. With reference again to FIG. 6, the plasticized local material 179 forms a layer along the surface defining the void space (e.g., the as-cast hole and/or pilot hole drilled in the as-cast hole) and also may surround the entirety of the void space, thereby forming a plasticized hole 180. More particularly, as the plasticized local material 179 subsequently cools, the plasticized local die-cast material 179 closes the casting defect in the vicinity of the surface of the hole and forms a sealing layer or zone 181 between the hole and rest of the die-cast material surrounding the hole as shown schematically in FIG. 6. The plasticized local material 179 may also flow into the casting defect 162, thereby sealing any leak path formed by the casting defect. In various embodiments, the width of the sealing zone 181 formed by the plasticized local material 179 is in a range of approximately 1 to 2 mm, but may be larger or smaller than this range.

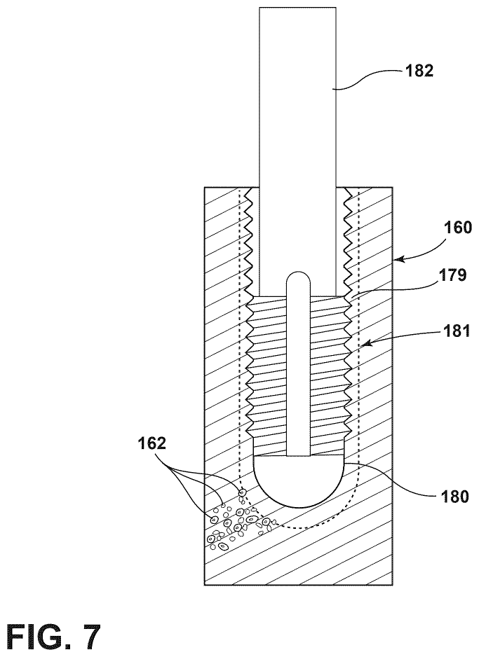

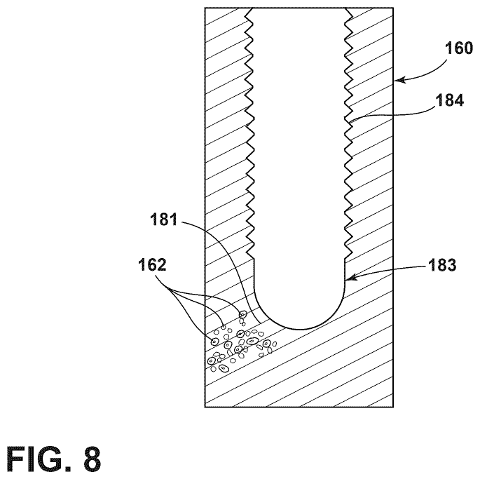

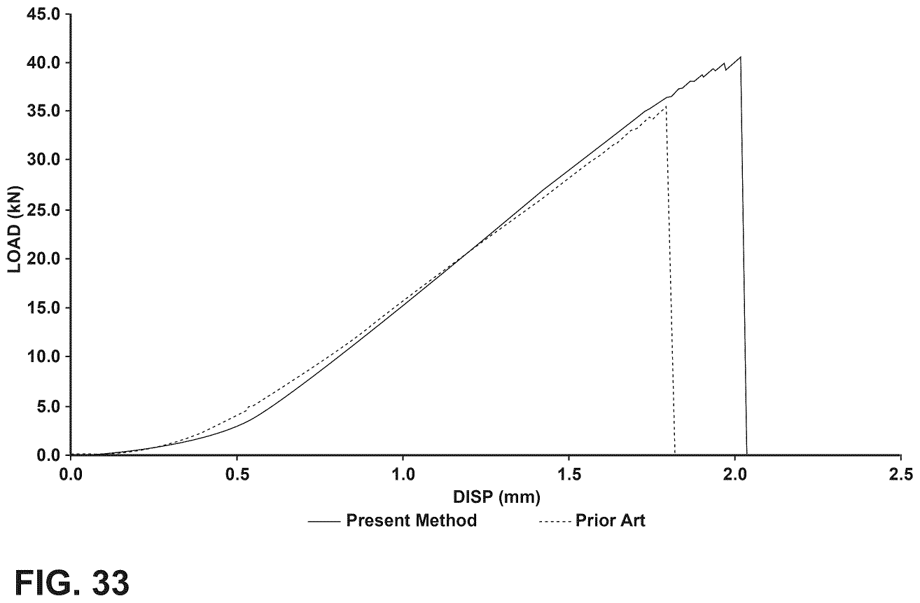

Turning to FIGS. 7 and 8, subsequent to forming the plasticized hole 180, the method may further include at step S112 threading of the plasticized hole using a conventional cutting or forming tap 182 that is adapted to form threads within the hole. The cutting or forming tap 182 is actuated within the plasticized hole 180 to form a threaded bolt hole 183 including threads 184 in the plasticized local material 179 along the wall of the bolt hole 183. The threaded bolt hole 183 is ready for use. The threads 184 in the bolt hole 183 may be sized to receive a fastener such as, by way of example, a M8 or M6 bolt. As a result of the refined grain structure in the zone 180 of plasticized local material 179, the newly formed threads 184 of the bolt hole 183 are as strong or stronger than threads that would have been drilled and tapped in the as-cast hole 168 of the base casting prior to the performance of the method. For example, with reference to the graph in FIG. 33, in a laboratory example an approximately 5 kN higher failure strength was achieved by a bolt hole drilled and tapped accordingly to the method disclosed herein in comparison to a bolt hole drilled and tapped into the die-cast material in accordance with conventional drilling and tapping methods. In the example, M8 sized bolt holes were formed, and 15 mm of thread engagement was used in the bolt holes. The sample according to the present method (T214) failed at 40.4831 kN whereas the sample according to the prior art failed at 35.4602 kN. Furthermore, as can be seen in FIG. 8, the zone 181 of plasticized local material forms a sealed barrier between the threaded bolt hole 183 and the porosities 162 of the casting defect.

After repeated use of the mechanical bit through multiple iterations of the steps above, die-cast material may become built up around the working portion of the mechanical bit which may alter the performance of the mechanical bit. Therefore, an optional additional step after removing the mechanical bit from the void space of the die-cast part is to clean and remove material from the working portion of the mechanical bit. The cleaning step is not particularly limited as long as it is capable of removing excess material from the mechanical bit. For example, the working portion of the mechanical bit may be cleaned using a lathe the sand away the excess material and/or to cut some of the excess material so that it can be knocked off the mechanical bit. The cleaning step may be performed after each iteration of the method steps with a particular mechanical bit, or may be performed after a number of iterations using the same mechanical bit, such as, for example, three iterations, five iterations, eight iterations, or ten iterations.

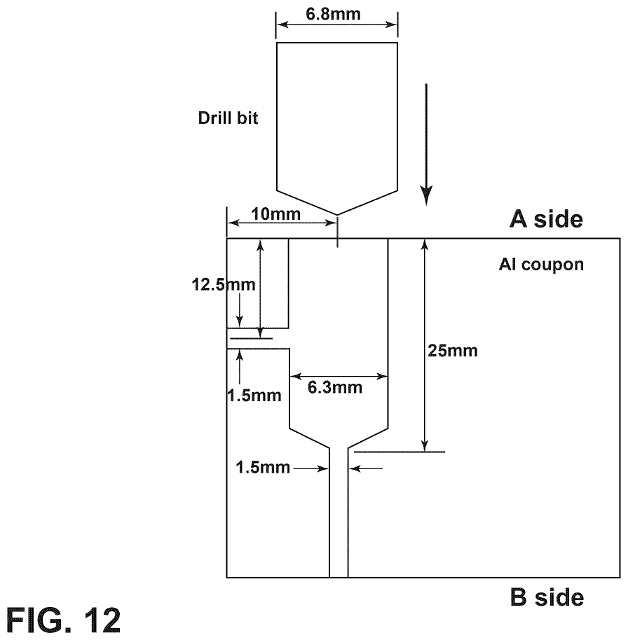

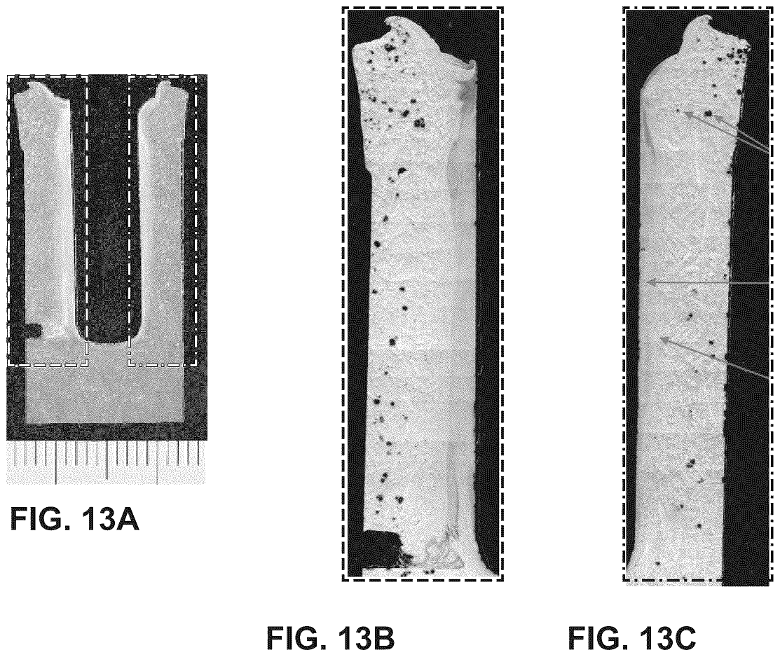

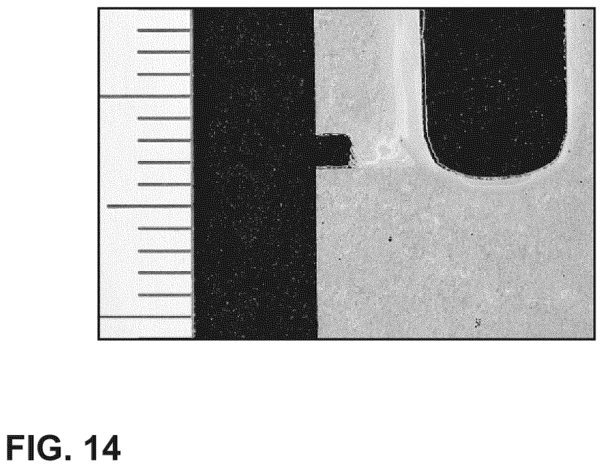

Turning next to FIGS. 12-14, in a laboratory simulation shown schematically in FIG. 12, a simulated void space in the form of a screw hole was formed in a workpiece of die-cast aluminum. Small holes were drilled in the side and/or the bottom of the screw hole to simulate leak paths from the screw hole. The mechanical bit was advanced axially (plunged) into the screw hole, and friction between the mechanical bit and the screw hole wall plasticized local die-cast material surrounding the screw hole. After operation of the mechanical bit, a section of the die-case workpiece was taken to reveal the resulting structure in the vicinity of the screw hole as shown in the images in FIGS. 13A-C and 14. Porosities were absent from the region surrounding the screw hole, and the grain structure of the die-cast material is much finer in this region compared with the grain structure of the rest of the workpiece. Further, the plasticized material flowed into and closed the simulated leak path at the bottom left of the workpiece.

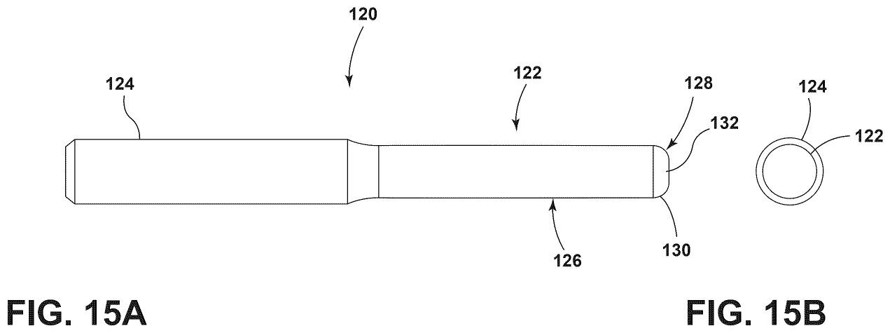

With reference now to FIGS. 15A-32C, the mechanical bit, and particularly the working portion of the mechanical bit, may have a variety of different geometrical configurations. Generally, the body of the bit is configured to generate plasticized local material along a surface defining a void space in a die-cast part, such that the plasticized local material closes a casting defect formed in the die-cast part. The mechanical bit is preferably formed of a material that has a high toughness at elevated temperatures. For example, the mechanical bit may be formed of a high-temperature tool steel, a nickel-based super alloy, or other similar material having high strength/hardness/durability at elevated temperatures. Specific examples of materials suitable for the mechanical bit may include, but are not limited to, high-speed steel (HSS), W360 steel, and MP159 nickel alloy.

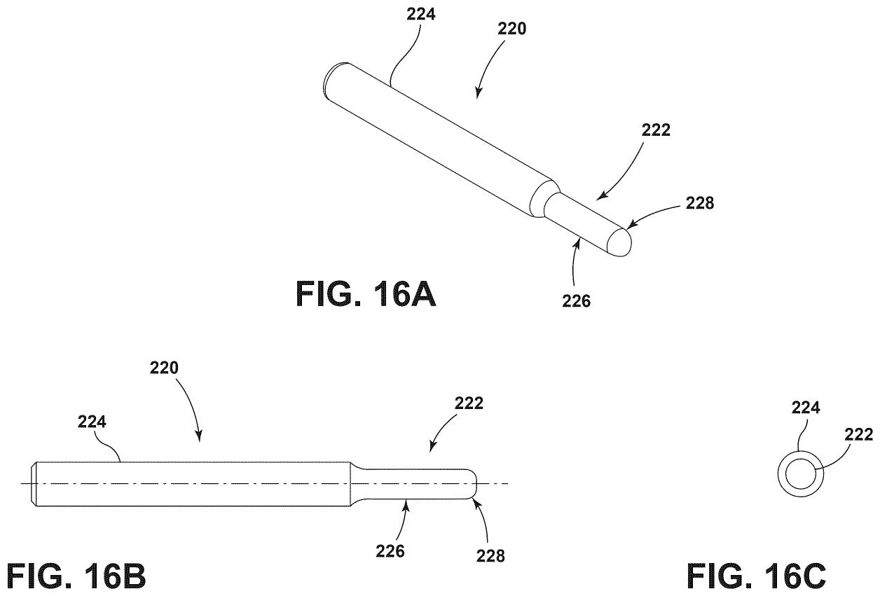

Turning first by example to FIGS. 15A-B, the mechanical bit 120 includes a body 122 and a shank 124. The body 122 is elongated, extends axially from the shank 124. In various embodiments, the shank 124 is wider than the body 122. By way of example only, the shank may be approximately 10.0 mm in diameter while the body may be approximately 6.8 mm in diameter. Also, by way of example only, the body may have a length of approximately 25 mm. The body 122 includes a working portion 126 that performs work on a workpiece such as a die-cast part. The working portion 126 includes a head 128 at a terminal, distal end that is distal from the shank 124. The body 122 also may be referred to as a “probe.” As shown in FIGS. 15A-B, in one embodiment and in a basic configuration (“featureless”), the working portion 126 is mainly cylindrical with a smooth surface and has a generally constant cross-sectional shape between the shank 124 and the head 128. The head 128 includes a blunt surface 130. Particularly, in this embodiment, the head 128 is rounded and terminates in a tip 132 that is a flat surface in a plane that is perpendicular to the axial direction of the mechanical bit 120. Alternatively, the head 228 of the mechanical bit 220 may be rounded such as a hemispherical shape without a flat surface, such as shown by example in FIGS. 16A-C. The embodiment of the mechanical bit 220 is otherwise generally identical to the mechanical bit 110, including a body 222, shank 224, and working portion 226. The configuration shown in FIGS. 15A-B and 16A-C may also be referred to as a “bull nose” configuration.

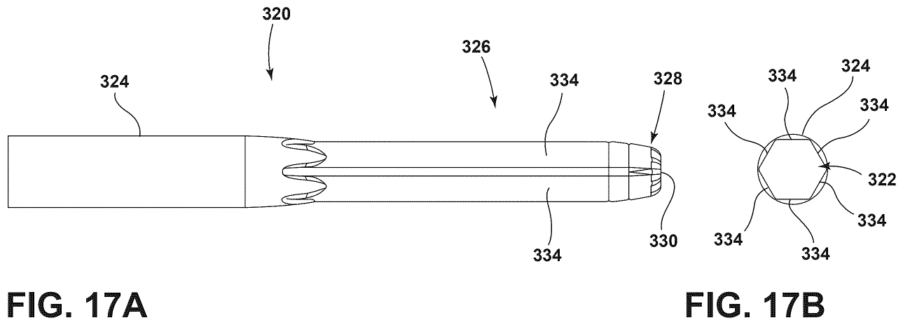

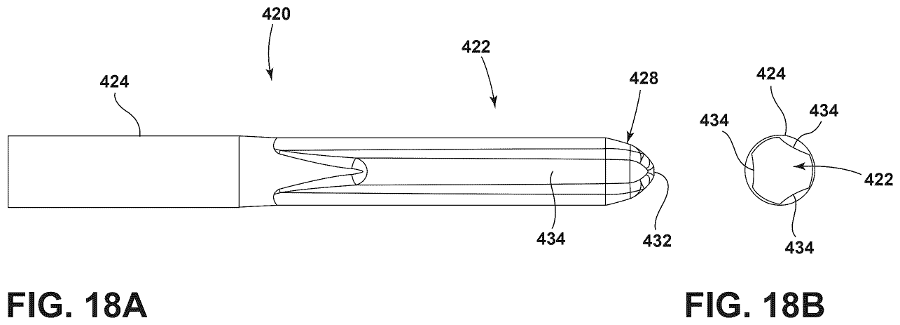

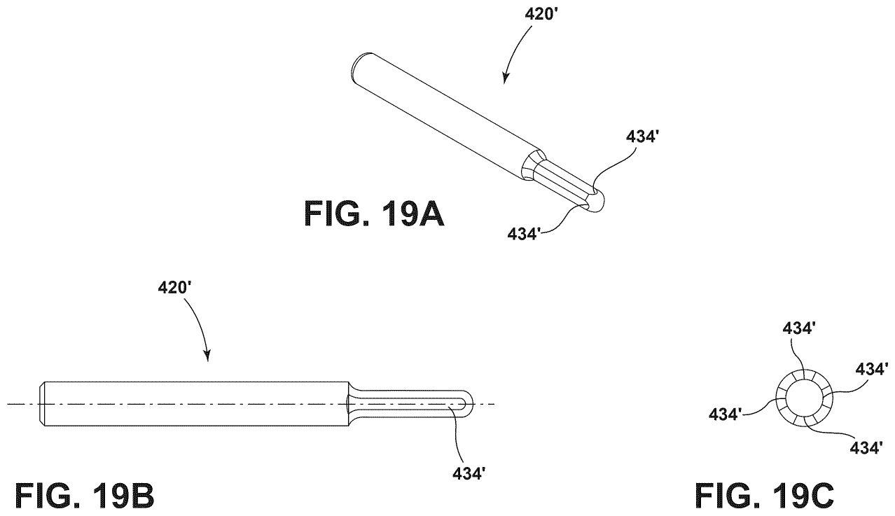

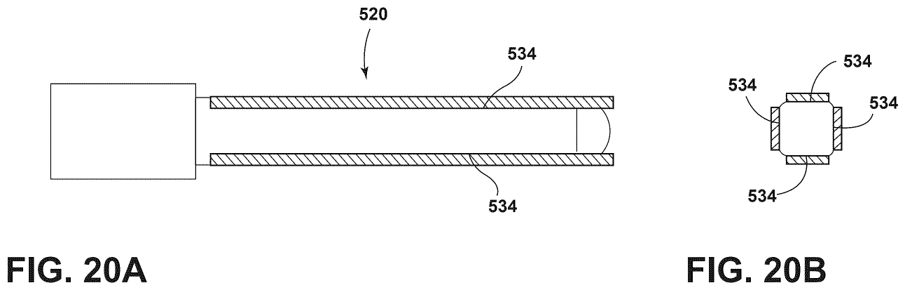

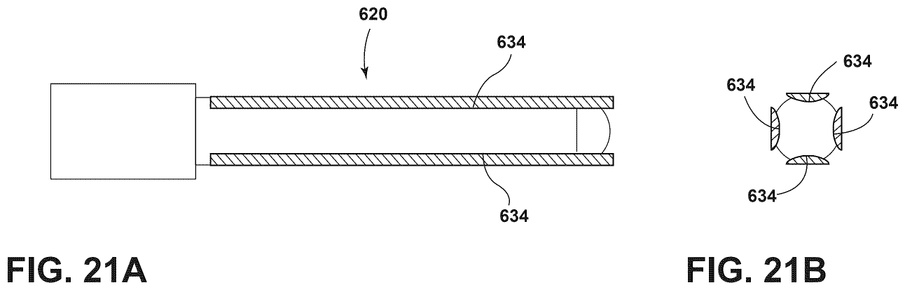

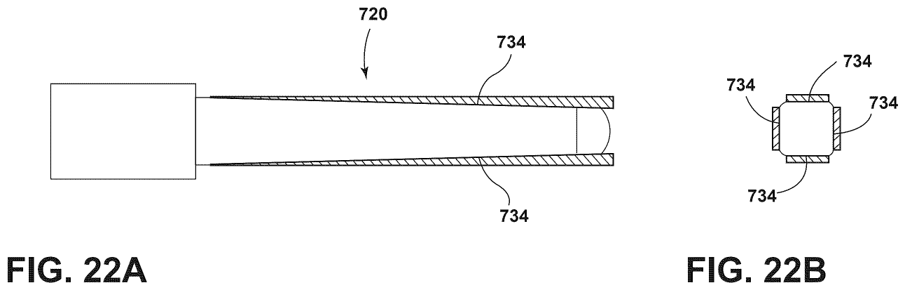

In other embodiments, the mechanical bit includes a plurality of lobes which also may be referred to as flutes. As shown by example in FIGS. 17A-B, in a 6-lobe configuration the lobes 334 of the mechanical bit 320 may be straight in the axial direction of the body 322 and flat in the radial direction of the body 322. In these configurations, the working portion 326 may have a generally polygonal cross-sectional shape between the shank 324 and the head 328. The working portion 326 terminates in a head 328 that includes a flat surface 330. Alternatively, as shown in FIGS. 18A-B, in a 3-lobe configuration the lobes 434 of the mechanical bit 420 may be straight in the axial direction of the body 422 but curved in the radial direction of the body 422 from the shank 424 to the head 428. Further, the head 428 may be rounded or curved towards the tip 432. The number of lobes is not particularly limited, but in various embodiments may range from three to six lobes, for example, three-lobe configurations (FIGS. 18A-B), four-lobe configurations (FIGS. 19A-C illustrating a mechanical bit 420′ having curved lobes 434'), and six-lobe configurations (FIGS. 17A-B). As shown schematically in FIGS. 20A-B, each lobe 534 of the mechanical bit 520 may be flat in both the axial and radial directions, and each lobe also may not be tapered in the axial direction of the body such that the “depth” of the lobe is generally constant. A similar configuration is shown schematically in FIGS. 21A-B, except that each lobe 634 of the mechanical bit 620 is curved in the radial direction. Alternatively, as shown schematically in FIGS. 22A-B, each lobe 734 of the mechanical bit 720 may be tapered in the axial direction of the body such that the “depth” of each lobe increases in a direction from the shank to the head. Stated differently, in the tapered configuration, the size of the cross-section of the working portion decreases from the shank to the head. It should be understood that the portions of FIGS. 20A-B, 21A-B, and 22A-B shown with cross-hatch markings are present to aide in the schematic illustration of the shape and configuration of the mechanical bits shown, and in fact no material is present in those portions. Stated differently, those portions in cross-hatch are not physically present and are not part of the physical structure of the mechanical bits shown.

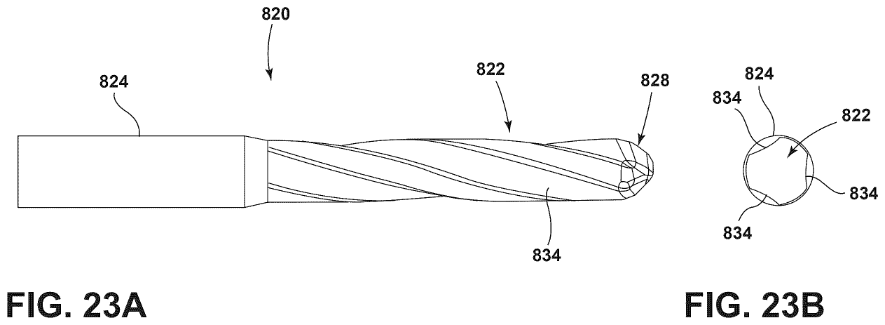

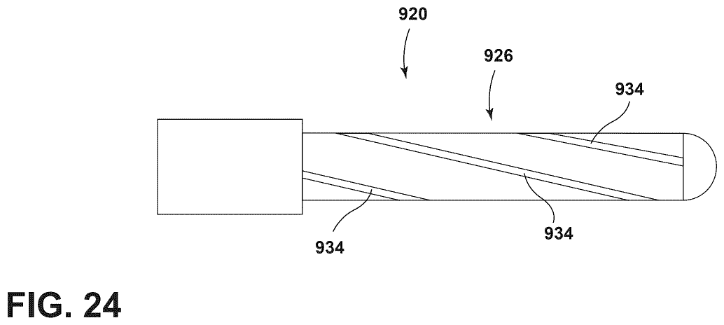

In yet other embodiments, the mechanical bit 820 may have lobes 834 that are helical (spiraled) in the axial direction of the body 822 from the shank 824 to the head 828 as shown in a three-lobe configuration in FIGS. 23A-B. Each lobe 834 is also curved in the radial direction of the body 822. In another embodiment, the working portion 926 of the mechanical bit 920 may have three helical lobes 934 that are flat in the radial direction as shown schematically in FIG. 24.

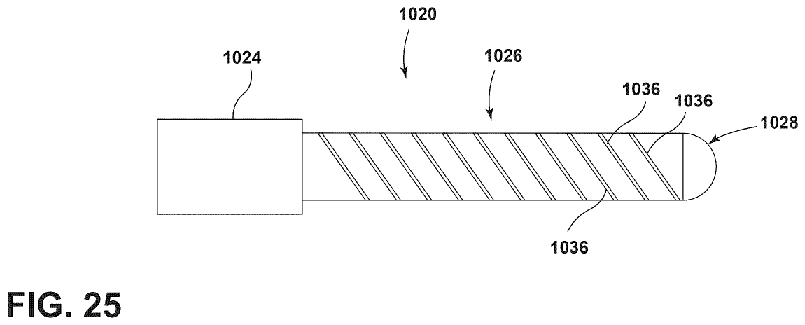

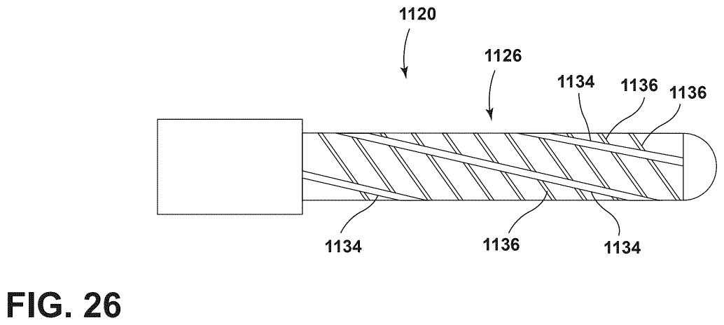

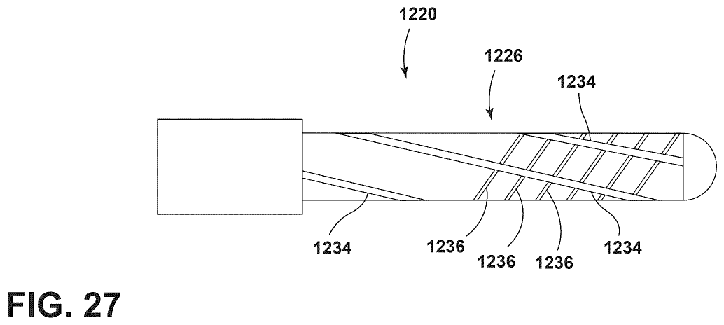

Turning to FIG. 25, the working portion 1026 of the mechanical bit 1020 may include threads 1036 (shown schematically) from the shank 1024 to the head 1028, and the head may be rounded. In still other embodiments, the working portion 1126 of the mechanical bit 1120 may include helical lobes 1134 and also may include threads 1136 that overlap generally the entirety of the helical lobes 1134 as shown schematically in FIG. 26. Further, the threads may turn in the same direction as the helical lobes, such as both being clockwise or both being counterclockwise. In yet other embodiments as shown schematically in FIG. 27, the threads 1236 of the working portion 1226 of the mechanical bit 1220 may turn in an opposite direction as the lobes 1234, such as one being clockwise and the other being counterclockwise. Further, the threads 1236 may only overlap a portion of the helical lobes 1234.

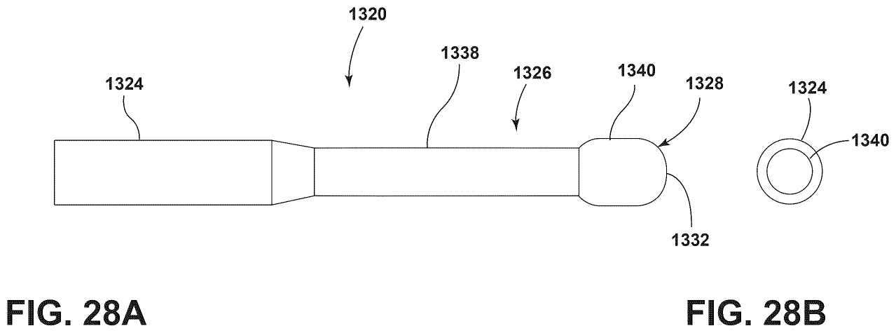

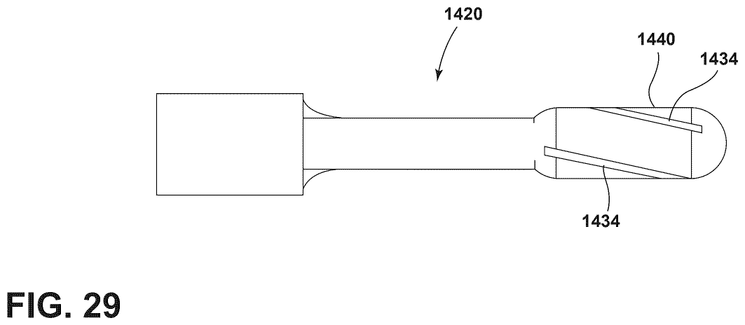

Turning next to FIGS. 28A-B, in yet other embodiments the working portion 1326 of the mechanical bit 1320 includes a cylindrical section 1338 and an increased diameter section 1340. The cylindrical section 1338 is adjacent the shank 1324. The increased diameter section 1340 is adjacent the cylindrical section 1338 and between the cylindrical section 1338 and the head 1328 such that the working portion 1326 has the appearance of a “lollipop” configuration. The increased diameter section 1340 may also be generally cylindrical in cross-section, and the head 1328 may be generally rounded and terminate in a tip 1332 that is a flat surface. The increased diameter section 1340 also may be significantly shorter that the cylindrical section 1338, such as, for example, approximately one-third, one-quarter, or one-fifth of the length of the cylindrical section. By way of example only, the shank 1324 may have a diameter of approximately 10.0 mm, the cylindrical section 1338 may have a diameter of approximately 6.0 to 6.3 mm, the increased diameter section 1340 may have a diameter in a range of approximately 6.6 to 6.8 mm and may have a length of approximately 10.0 mm. In still other embodiments as shown schematically in FIG. 29, the increased diameter section 1440 of the mechanical bit 1420 may include one or more lobes 1434, such as one or more helical lobes or a plurality of flat, straight lobes.

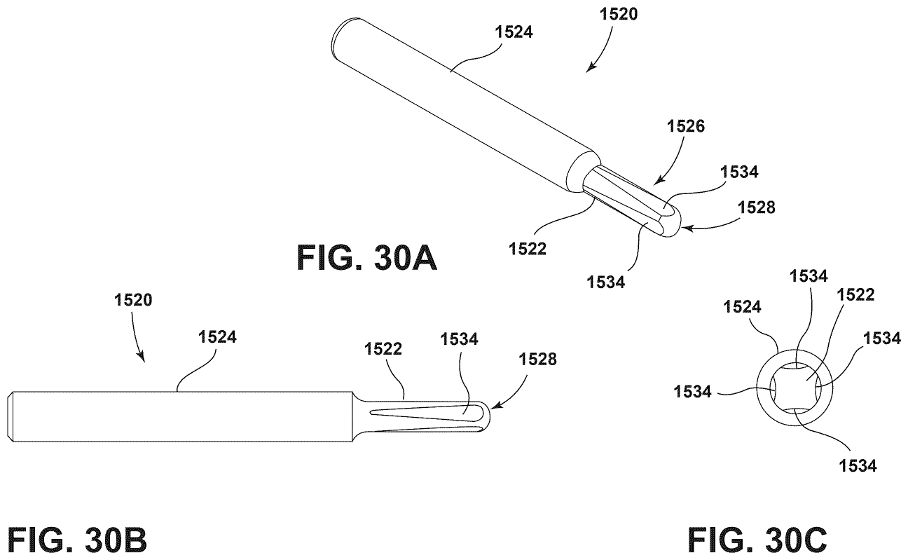

Turning next to FIGS. 30A-C, in specific embodiments the working portion 1526 of the mechanical bit 1520 has four tapered lobes 1534 that are tapered in the axial direction of the body 1522 such that the “depth” of each lobe 1534 increases in a direction from the shank 1524 to the head 1528. The head 1528 is rounded. The mechanical bit 1520 may have a length of approximately 100 mm and the working portion 1526 may have a length of approximately 25 mm and a diameter of approximately 6 to 7 mm. The lobes 1534 may taper at an angle of approximately 1.5 degrees.

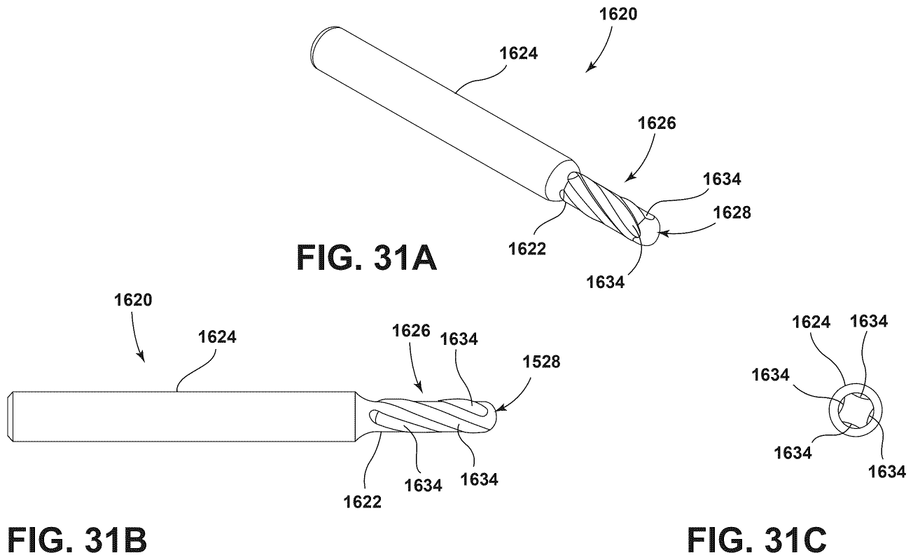

With reference to FIGS. 31A-C, in other specific embodiments the working portion 1626 of the mechanical bit 1620 has four helical lobes 1634 extending along the body 1622 from the shank 1624 to the head 1628, and the head 1628 is rounded. The mechanical bit 1620 may have a length of approximately 100 mm and the working portion 1626 may have a length of approximately 25 mm. The depth of each helical lobe 1634 may be approximately 0.4 mm with a pitch of approximately 50 mm. The working portion 1626 may have a diameter of approximately 6 to 7 mm.

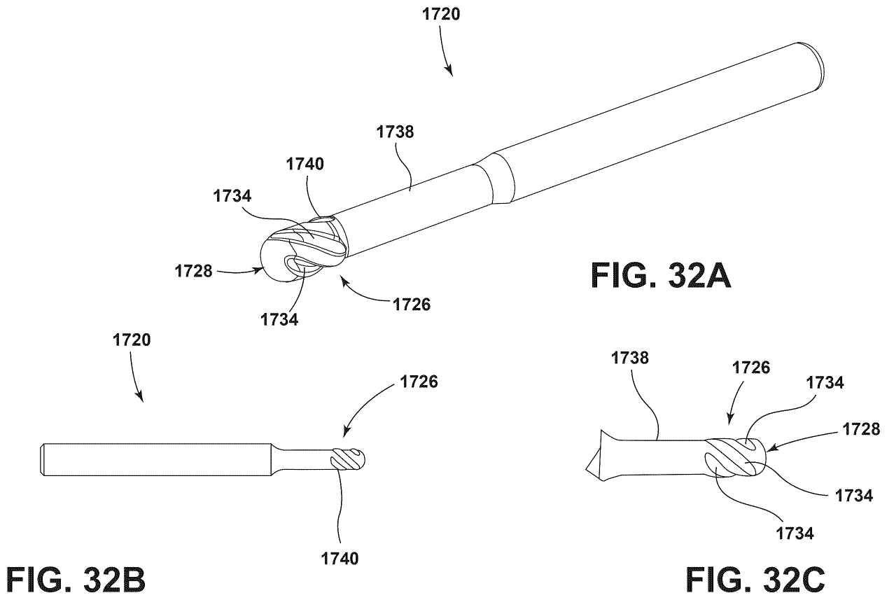

With reference next to FIGS. 32A-C, in yet other specific embodiments the mechanical bit 1720 has a lollipop configuration in which the increased diameter section 1740 of the working portion 1726 has four helical lobes 1734 that extend from the cylindrical section 1738 to the head 1728. The mechanical bit 1720 may have a length of approximately 100 mm and the working portion 1726 may have a length of approximately 25 mm. The increased diameter section 1740 may have a diameter of approximately 6.8 mm. Each lobe 1734 may have a depth of approximately 0.4 mm and a pitch of approximately 22 mm.

The various mechanical bit geometries and surface features including the lobes, tapers, threads, and lollipops aid in managing the plasticized material formed by operation of the bit within the void space to balance the generation of frictional heat with the flow of some material out of the void space. The mechanical bit must be capable of generating heat along the walls of the void space to plasticize the local die-cast material, while at the same time not generating excess pressure that could cause the walls of the void space to bulge out. The mechanical bit geometries and surface features balance frictional heat generation with removing material from the void space.

In various embodiments, the mechanical bit may be solid or alternatively may be hollow. In particular embodiments, hollow mechanical bits may be used for wide void spaces such as large diameter bores. A hollow, tubular mechanical bit geometry may enhance frictional heating of local die-cast material within the bore or other void space, by reducing the amount of heat energy lost to heating of the material that forms the mechanical bit. In other words, a solid mechanical bit has more conductive material that can absorb heat in comparison to a hollow mechanical bit. In yet other further embodiments, the mechanical bit may be of a single-piece construction, or alternatively may be a multi-piece bit including inserts and/or other component(s) that are assembled together. In particular embodiments, multi-piece mechanical bis may be used for wide void spaces such as large diameter bores.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of repairing a casting defect in a die-cast part, the method comprising:
operating a mechanical bit within a void space formed in a die-cast part to generate plasticized local material along an inner surface of the void space by friction to close one or more casting defects in a vicinity of the void space.

2. The method of claim 1, wherein the void space is one of: i) a hole formed in a die-cast part; ii) a hole bored in the die-cast part; iii) a channel formed in the die-cast part; and iv) a passage formed in the die-cast part.

3. The method of claim 1, wherein the casting defect is a porosity feature formed in the die-cast part.

4. A method of repairing a casting defect in a die-cast part, the method comprising the steps of:
providing a tool including a mechanical bit, the mechanical bit including a shank and a body extending from the shank in an axial direction;
actuating the tool to rotate the mechanical bit;
advancing the mechanical bit in at least one of the axial direction or a radial direction into a void space formed in the die-cast part;
wherein friction between the mechanical bit and a surface within the void space generates heat to plasticize local die-cast material at the surface to close the casting defect in a vicinity of the surface of the void space, thereby sealing the surface within the void space.

5. The method of claim 4, wherein the tool forms a plasticized layer: i) along the surface within the void space; ii) around the entirety of the void space; or iii) both i) and ii).

6. The method of claim 4, wherein the tool is advanced in both the axial direction and the radial direction.

7. The method of claim 4, wherein the mechanical bit is rotated at a rate of up to 15,000 rpm.

8. The method of claim 4, wherein the mechanical bit is advanced at a rate of between 10 mm/min and 500 mm/min.

9. The method of claim 4, wherein the body of the mechanical bit includes a cylindrical surface and a blunt head at an end of the cylindrical surface.

10. The method of claim 4, wherein the void space is one of: i) a hole formed in a die-cast part; ii) a hole bored in the die-cast part; iii) a channel formed in the die-cast part; and iv) a passage formed in the die-cast part.

11. The method of claim 4, wherein the casting defect is a porosity feature formed in the die-cast part.

12. A tool for repairing a casting defect in a die-cast part, the tool comprising:
a mechanical bit operable by an actuator device, the mechanical bit comprising:
a shank configured to fit into the actuator device; and
an elongated body extending in an axial direction from the shank;
wherein the body is configured to generate plasticized local material along a surface defining a void space in a die-cast part, the plasticized local material closing a casting defect formed in the die-cast part.

13. The tool of claim 12, wherein the body includes a working portion, the working portion including a head at a distal end.

14. The tool of claim 13, wherein: i) the head includes a blunt surface; ii) the head is rounded; or iii) the head terminates in a tip that is a flat surface.

15. The tool of claim 13, wherein the working portion is cylindrical, and the head is rounded.

16. The tool of claim 13, wherein the working portion includes a plurality of lobes.

17. The tool of claim 16, wherein the lobes are: i) straight in the axial direction of body; ii) curved in the axial direction of the body; iii) helical; iv) flat in a radial direction of the body; or v) curved in a radial direction of the body.

18. The tool of claim 13, wherein the working portion is tapered in the axial direction of the body.

19. The tool of claim 13, wherein the working portion has: i) a generally constant cross-sectional shape between the shank and the head; ii) a polygonal cross-sectional shape; or iii) both i) and ii).

20. The tool of claim 13, wherein the working portion includes threads.

21. The tool of claim 20, wherein the working portion further includes helical lobes, and the threads overlap the helical lobes.

22. The tool of claim 21, wherein: i) the threads turn in the same direction as the lobes; or ii) the threads turn in an opposite direction as the lobes.

23. The tool of claim 13, wherein the working portion includes a cylindrical section and an increased diameter section, the increased diameter section being adjacent the cylindrical section and between the cylindrical portion and the head.

24. The tool of claim 23, wherein: i) the increased diameter section includes one or more helical lobes; or ii) the increased diameter section includes a plurality of flat, straight lobes.

25. A method of repairing a casting defect in a die-cast part, the method including the step of operating the tool of claim 12.
